(19) United States
(12) Patent Application Publication
(10) Pub. No.: US 2004/0261513 A1
(43) Pub. Date: Dec. 30, 2004

(54) Method and apparatus for monitoring tire pressure with a color indicator

(76) Inventors: Fred Joseph Wiseman JR., Anaheim Hills, CA (US); Ronald David Cook, Riverside, CA (US)

Correspondence Address: Pillsbury Winthrop LLP, Intellectual Property Group, Suite 2800, 725 South Figueroa Street, Los Angeles, CA, 90017-5406, US

(21) Appl. No.: 10/857,991

(22) Filed: Jun. 1, 2004

Related U.S. Application Data
(63) Continuation-in-part of application No. 10/215,179, filed on Aug. 8, 2002, now abandoned.

(51) Int. Cl. G01M 17/02

(52) U.S. Cl. 73/146

(57) ABSTRACT

Disclosed herein is a method and apparatus for monitoring the air pressure of a tire. Various colors are displayed by the apparatus to denote an inflation level of the tire, and the apparatus may remain coupled to the air nozzle of a tire indefinitely. The apparatus may include a diaphragm that deforms in response to an air pressure differential on opposing sides thereof. Deformation of the diaphragm may alter the position of a color indicating cup, such that a color is displayed through an observation window, informing a user as to the inflation state of the tire. Further provided is a method for monitoring tire pressure in high pressure tires.

This application is a continuation-in-part of U.S. patent application Ser. No. 10/215,179, filed Aug. 8, 2002.

### FIELD OF THE INVENTION

The present invention relates to the monitoring of air pressure in tires. More particularly, the invention relates to a method and apparatus for monitoring air pressure in tires utilizing colors to indicate a level of tire pressure. In further embodiments, the invention relates to the monitoring of air pressure in high pressure tires.

### BACKGROUND OF THE INVENTION

Below optimum air pressure in the tires of automobiles, motorcycles and trucks is frequently associated with poor gas mileage, an increased risk of traffic accidents and greater wear on the tires themselves. Similarly, low tire pressure on other, non-motorized vehicles, such as bicycles and trailers, can have similar ramifications; increased risk of losing control of the vehicle and more rapid deterioration of the tires. It is therefore generally advantageous to maintain at least near optimum air pressure in the tires of a vehicle or other transportation apparatus.

Monitoring tire pressure can be an inconvenient task, and individuals oftentimes forsake safety and fuel economy for time savings. Manual pressure gauges may require one to remove a cap from an air nozzle, couple the gauge to the nozzle, observe an indication of tire pressure from the gauge, remove the gauge and reattach the cap to the nozzle. This arduous task must then be repeated for every tire on the vehicle; especially burdensome on a vehicle with many tires, such as large trucks that may have eighteen or more tires.

A limitation of many conventional tire pressure monitoring devices is their inability to function properly at high tire pressures (i.e., pressures above about 60 psi). When subjected to such high pressures, conventional devices may be unable to accurately indicate an inflation level of a tire, or, more dramatically, they may fail altogether and mechanically rupture. A large sector of the tire pressure monitoring market is therefore unable to take advantage of this technology; in particular, the trucking industry, in which tire pressures are routinely at or above 60 psi. Since the problems associated with underinflated tires are particularly rampant in the trucking industry (i.e., poor gas mileage, premature tread loss, etc.), an adaptation to the conventional tire pressure monitoring technology is needed to address this limitation.

### SUMMARY OF THE INVENTION

It is therefore an object of an embodiment of the present invention to provide an apparatus for monitoring the air pressure of a tire that obviates, for practical purposes, the above-mentioned limitations. The apparatus of the present invention allows a user to monitor the air pressure of a tire, without the need to proceed through the series of steps enumerated above (i.e., removal of a cap, coupling of a device to an air nozzle, observation of a tire pressure reading, removal of the device, and subsequent reattachment of the cap). The apparatus may instead be coupled to the air nozzle of a tire, and may remain coupled to the nozzle for an indefinite period of time. Moreover, the apparatus of the present invention may monitor tire pressure in high pressure tires (i.e., those with an optimum pressure level at or above 60 psi; hereinafter “high pressure tires”).

The apparatus may include a diaphragm that deforms in response to an air pressure differential on opposing sides thereof. Deformation of the diaphragm may alter the position of a color indicating cup or piston, such that a color is displayed through an observation window, informing a user as to the inflation state of the tire. In particular embodiments, the apparatus may display a first color when the tire pressure is near optimum, and a second color when the tire pressure is sufficiently low that it should be filled with air. In alternate embodiments, the apparatus may display yet a third color when the tire pressure is below optimum yet still in an acceptable range. A method of monitoring the air pressure of a tire utilizing the apparatus is further provided, as is a method for monitoring the air pressure of a high pressure tire.

### BRIEF DESCRIPTION OF THE DRAWINGS

FIG. 1 depicts an exploded view of a tire pressure monitoring apparatus in accordance with an embodiment of the present invention.

FIG. 2 depicts a cross-sectional view of the tire pressure monitoring apparatus of FIG. 1, in accordance with an embodiment of the present invention. The device is depicted in the state indicating that tire pressure is insufficient.

FIG. 3 depicts a cross-sectional view of the tire pressure monitoring apparatus of FIG. 1, in accordance with an embodiment of the present invention. The device is depicted in the state indicating that tire pressure is within an acceptable range, although not optimum.

FIG. 4 depicts a cross-sectional view of the tire pressure monitoring apparatus of FIG. 1, in accordance with an embodiment of the present invention. The device is depicted in the state indicating that tire pressure is at least near optimum.

FIG. 5 depicts an exploded view of a tire pressure monitoring apparatus in accordance with an embodiment of the present invention.

FIG. 6 depicts a cross-sectional view of the tire pressure monitoring apparatus of FIG. 5, in accordance with an embodiment of the present invention. The device is depicted in the state indicating that tire pressure is insufficient (i.e., tire pressure more than 20% below optimum).

FIG. 7 depicts a cross-sectional view of the tire pressure monitoring apparatus of FIG. 5, in accordance with an embodiment of the present invention. The device is depicted in the state indicating that tire pressure is low (i.e., tire pressure approximately 20% below optimum).

FIG. 8 depicts a cross-sectional view of the tire pressure monitoring apparatus of FIG. 5, in accordance with an embodiment of the present invention. The device is depicted in the state indicating that tire pressure is within an acceptable range, although not optimum (i.e., tire pressure approximately 10% below optimum).

FIG. 9 depicts a cross-sectional view of the tire pressure monitoring apparatus of FIG. 5, in accordance with an embodiment of the present invention. The device is depicted in the state indicating that tire pressure is at least near optimum.

### DETAILED DESCRIPTION OF THE INVENTION

Embodiments of the present invention describe a tire pressure monitoring apparatus that indicates an inflation level of a tire with colors, and a method of monitoring the air pressure of a tire utilizing the same. The tire pressure monitoring apparatus of the present invention is suitable for use in combination with a variety of tires, spanning a wide array of optimum pressures. In particular, the tire pressure monitoring apparatus may be used on high pressure tires (i.e., those with an optimum pressure level at or above 60 psi); although it is similarly well suited for use on tires with optimum pressure levels substantially less than 60 psi, such as those conventionally used on an automobile or bicycle.

The apparatus may be coupled to an air nozzle of a tire, and may remain coupled to the air nozzle indefinitely; thereby rendering the continued observation of tire pressure more convenient when compared with conventional devices, such as a traditional tire pressure gauge. Furthermore, the apparatus may be constructed of fewer parts than other tire pressure monitoring devices, potentially rendering the apparatus of the present invention more cost-effective to produce, more convenient to assemble and less likely to fail owing to human error in manufacturing.

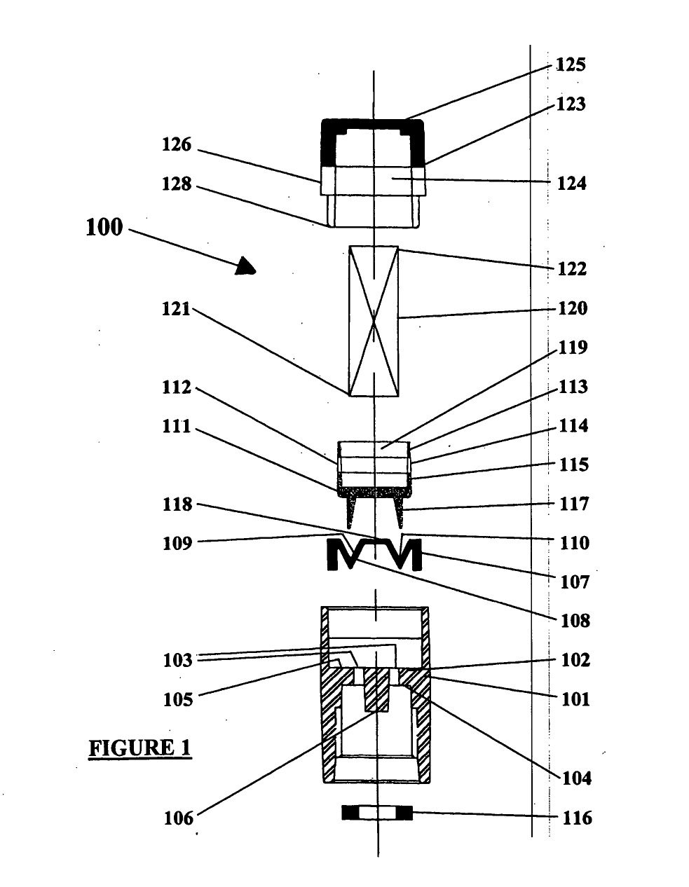

As depicted in FIG. 1, in a first embodiment, a tire pressure monitoring apparatus 100 may include a housing 101 that may be configured to attach to the exterior threading of an air nozzle of a tire (not shown). The housing 101 may be generally cylindrical or hexagonal in shape, although other geometric configurations may be utilized, for example, when desirable for ease of manufacturing. The housing 101 may include a partition 102 at or near the longitudinal center thereof, and may further include at least one air hole 103 traversing the partition 102 to provide air flow communication between opposing sides of the partition 102 (i.e., the nozzle side 104 and the diaphragm side 105). In a preferred embodiment, as depicted in FIG. 1, there may be two air holes 103.

The housing 101 may further include a valve stem 106 protruding from the center of the partition 102 in the direction of the air nozzle (not shown). The valve stem 106 may contact a central member of a conventional air nozzle thereby causing the air nozzle to open and provide gaseous communication between the interior of the tire (not shown) and the interior of the tire pressure monitoring apparatus 100. Further gaseous communication may be provided by the at least one air hole 103 disposed in the partition 102 of the housing 101. Moreover, in a preferred embodiment, an O-ring 116 may be included between the nozzle side 104 of the partition 102 and the air nozzle (not shown) to provide a substantially airtight seal between the tire pressure monitoring apparatus 100 and the air nozzle (not shown) when coupled to one another.

A diaphragm 107 may further be included in the tire pressure monitoring apparatus 100 of the present invention (FIG. 1). The diaphragm 107 may be constructed of any suitable, resilient material that has sufficient elastomeric properties such that the diaphragm 107 may deform owing to a predetermined air pressure differential on opposing sides thereof (i.e., a partition side 108 and a color indicator side 109), and may further return to its original configuration upon reduction of the air pressure differential to a predetermined level. The diaphragm 107 may be disposed on the diaphragm side 105 of the partition 102, and may be pressure-fit against the interior wall of the housing 101. In preferred embodiments, gaseous communication is not provided between the partition side 108 and the color indicator side 109 of the diaphragm 107. In the absence of such gaseous communication, an air pressure differential is created across the diaphragm 107; thereby deforming the diaphragm 107 to indicate the internal air pressure of the tire.

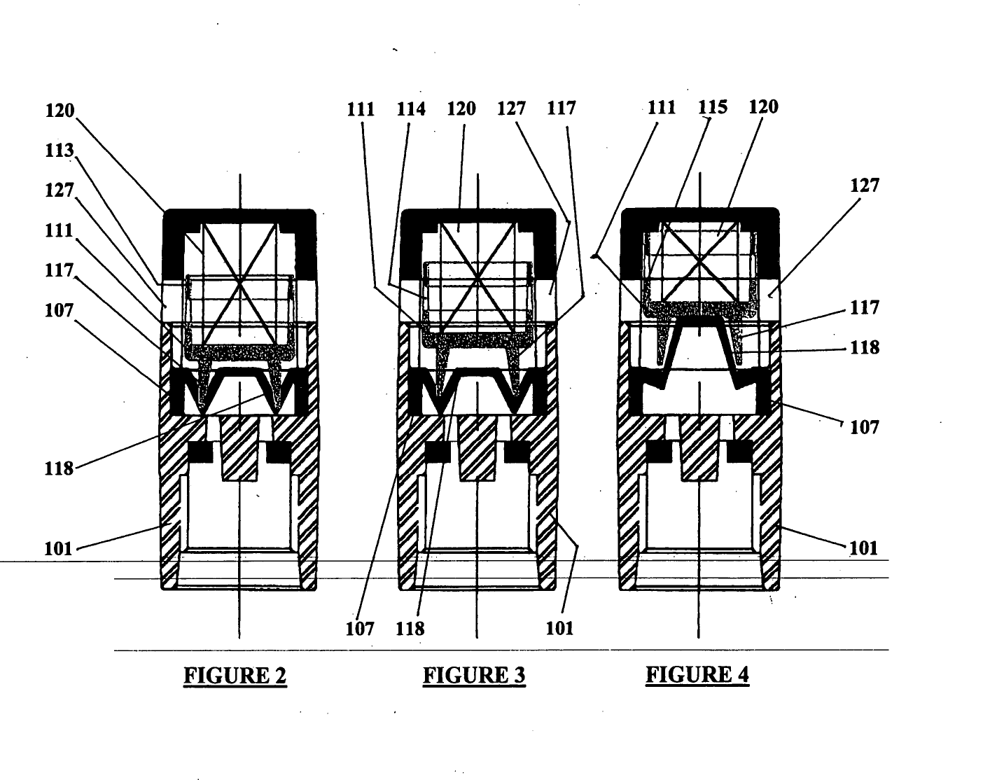

The diaphragm 107 may further include a depression 110 that allows the diaphragm 107 to deform when the air pressure differential on opposing sides 108,109 thereof reaches a predetermined threshold level; deforming further as the air pressure differential increases, up to a maximum deformation (FIGS. 2, 3 and 4). The material utilized to construct the diaphragm 107 may be selected to equate with differing threshold levels (i.e., to configure the tire pressure monitoring apparatus 100 for use with different types of tires, each having different air pressure characteristics and requirements). As such, the tire pressure monitoring apparatus 100 of the present invention may be configured for use with a range of tires, such as bicycle tires, automobile tires, truck tires and other types of tires that will be apparent to one of skill in the art. In particular embodiments, the tire pressure monitoring apparatus 100 of the present invention may be suitable for use in monitoring the tire pressure of high pressure tires.

In those embodiments of the present invention wherein the housing 101 is substantially cylindrical, the diaphragm 107 may similarly be roughly cylindrical in shape, and the depression 110 disposed therein may be roughly circular. The depression 110 may further define a center portion 118 of the diaphragm 107; the center portion 118 being that component of the diaphragm 107 that deforms upon application of an air pressure differential thereto. The center portion 118 of the diaphragm 107 is at or near a maximally deformed state when the tire pressure is at or near an optimum inflation level (FIG. 4); an intermediate deformation state when the tire pressure is within an acceptable range, although not near optimum (FIG. 3); and a resting state when the tire pressure is insufficient (FIG. 2), respectively.

The tire pressure monitoring apparatus 100 of the present invention may further include a color indicating cup 111 (FIG. 1). The colors that denote particular inflation levels of a tire may appear on the exterior wall 112 of the color indicating cup 111. In a preferred embodiment of the present invention, there are three such colors depicted in bands around the exterior wall 112 of the color indicating cup 111: a first color band 115 (e.g., green), a second color band 113 (e.g., red) and a third color band 114 (e.g., yellow). The first color band 115 may indicate that the tire pressure is at least near optimum; the second color band 113 may indicate that the tire pressure is insufficient; and the third color band 114 may indicate that the tire pressure is within an acceptable range, although not near optimum. Therefore, the deformation state (i.e., including the resting state, when the second color band 113 is visible) of the diaphragm 107 may cause the corresponding color band to become visible through an observation window 127, described in greater detail below.

The color indicating cup 111 may further include a diaphragm receiving member 117. The diaphragm receiving member 117 may be roughly cylindrical or conical in shape, depending upon the configuration of the diaphragm 107 and the center portion 118 thereof. The diaphragm receiving member 117 may mate with the depression 110 in the diaphragm 107, and may further be configured to receive the center portion 118 of the diaphragm 107 when the diaphragm 107 deforms owing to an air pressure differential on opposing sides 108, 109 thereof (FIGS. 3 and 4), and/or when the diaphragm 107 is in its resting state (FIG. 2).

The color indicating cup 111 may further include an interior cavity 119, configured to receive the color indicating cup end 121 of a spring 120. The spring 120 may be included to provide mechanical resistance against the color indicating cup 111, such that the color indicating cup 111 remains mated to the diaphragm 107. In various embodiments of the present invention, the mechanical resistance provided by the spring 120 may aid in maintaining a proper mating between the color indicating cup 111 and the diaphragm 107, and may additionally aid in forcing the diaphragm 107 from a deformed state (FIGS. 3 and 4) to a resting state (FIG. 2). However, in preferred embodiments of the present invention, the mechanical resistance provided by the spring 120 is only sufficient for maintaining a proper mating between the color indicating cup 111 and the diaphragm 107, and in such embodiments does not provide the requisite force to aid in transforming the diaphragm 107 back to a resting state.

As also depicted in FIG. 1, the tire pressure monitoring apparatus 100 may include a cover 123 that further includes an interior chamber 124 to operably receive a cover end 122 of the spring 120. The cover 123 may be geometrically configured to correspond to the shape of the housing 101 (i.e., it may be roughly cylindrical in shape in those embodiments wherein the housing 101 is roughly cylindrical in shape). In a preferred embodiment of the present invention, the cover 123 may also include both an opaque portion 125 and a transparent portion 126. The opaque portion 125 of the cover 123 may conceal at least a portion of the interior chamber 124. The transparent portion 126, on the other hand, preferably circumscribes the cover 123 to provide an observation window 127 (FIGS. 2, 3 and 4) through which one can view at least one color indicating the present inflation level of the tire to which the tire pressure monitoring device 100 is attached.

One or more colors may be displayed at a particular time through the observation window 127. Preferably, only one color is displayed when the air pressure of the tire falls within a range defined by the corresponding color band 113, 114 or 115. However, since the inflation level may be at or near a level that is between two of the ranges that the color bands 113, 114, 115 denote, portions of multiple color bands may be simultaneously visible through the observation window 127. For example, the color band indicating an insufficient inflation level 113 as well as the color band indicating an inflation level that is within an acceptable range, although not near optimum 114 may be simultaneously displayed through the observation window 127. The display of multiple colors through the observation window 127 may still provide a user with an indication of the air pressure of a tire; the pressure is simply between two of the ranges defined by the color bands 113, 114 or 115.

The cover 123 may further include a base 128 that contacts the diaphragm 107 when the cover 123 and housing 101 are assembled together. In this embodiment, depicted in FIG. 1, the cover 123 thereby aids in maintaining the pressure-fit between the diaphragm 107 and the housing 101, and secures the diaphragm 107 in place. This may aid in preventing the leakage of air from a tire through the tire pressure monitoring device 100, while also providing mechanical support for the diaphragm 107.

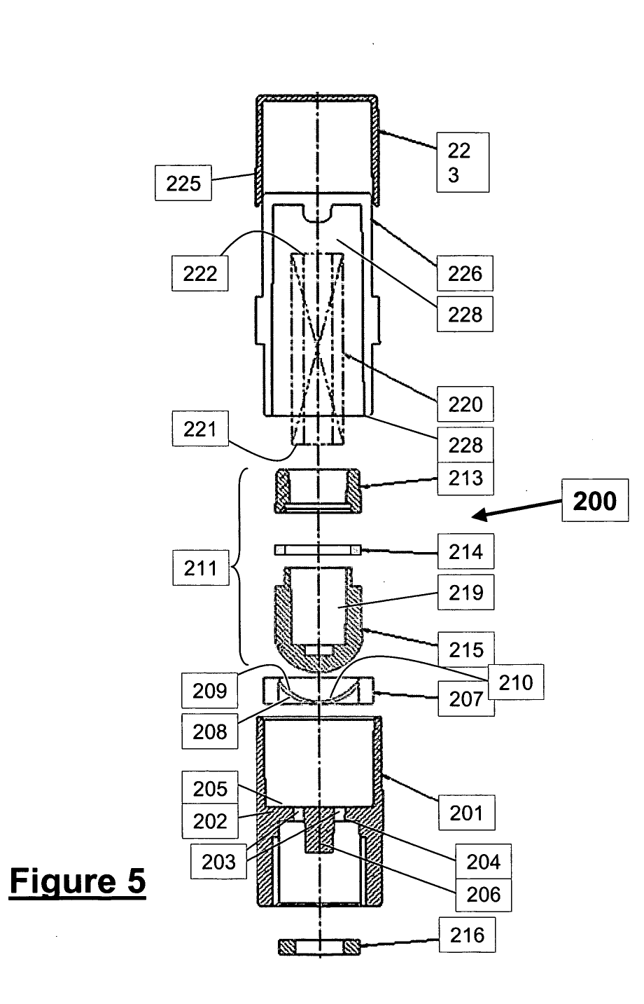

As depicted in FIG. 5, in a second embodiment of the present invention, a tire pressure monitoring apparatus 200 may include a housing 201 that may be configured to attach to the exterior threading of an air nozzle of a tire (not shown). The housing 201 may be generally cylindrical or hexagonal in shape, although other geometric configurations may be utilized, for example, when desirable for ease of manufacturing. The housing 201 may include a partition 202 at or near the longitudinal center thereof, and may further include at least one air hole 203 traversing the partition 202 to provide air flow communication between opposing sides of the partition 202 (i.e., the nozzle side 204 and the diaphragm side 205). In a preferred embodiment, as depicted in FIG. 5, there may be two air holes 203.

The housing 201 may further include a valve stem 206 protruding from the center of the partition 202 in the direction of the air nozzle (not shown). The valve stem 206 may contact a central member of a conventional air nozzle thereby causing the air nozzle to open and provide gaseous communication between the interior of the tire (not shown) and the interior of the tire pressure monitoring apparatus 200. Further gaseous communication may be provided by the at least one air hole 203 disposed in the partition 202 of the housing 201. Moreover, in a preferred embodiment, an O-ring 216 may be included between the nozzle side 204 of the partition 202 and the air nozzle (not shown) to provide a substantially airtight seal between the tire pressure monitoring apparatus 200 and the air nozzle (not shown) when coupled to one another.

A diaphragm 207 may further be included in the tire pressure monitoring apparatus 200 of the present invention (FIG. 5). The diaphragm 207 may be constructed of any suitable, resilient material that has sufficient elastomeric properties such that the diaphragm 207 may deform owing to a predetermined air pressure differential on opposing sides thereof (i.e., a partition side 208 and a color indicator side 209), and may further return to its original configuration upon reduction of the air pressure differential to a predetermined level. The diaphragm 207 may be disposed on the diaphragm side 205 of the partition 202, and may be pressure-fit against the interior wall of the housing 201. In preferred embodiments, gaseous communication is not provided between the partition side 208 and the color indicator side 209 of the diaphragm 207. In the absence of such gaseous communication, an air pressure differential is created across the diaphragm 207; thereby deforming the diaphragm 207 to indicate the internal air pressure of the tire.

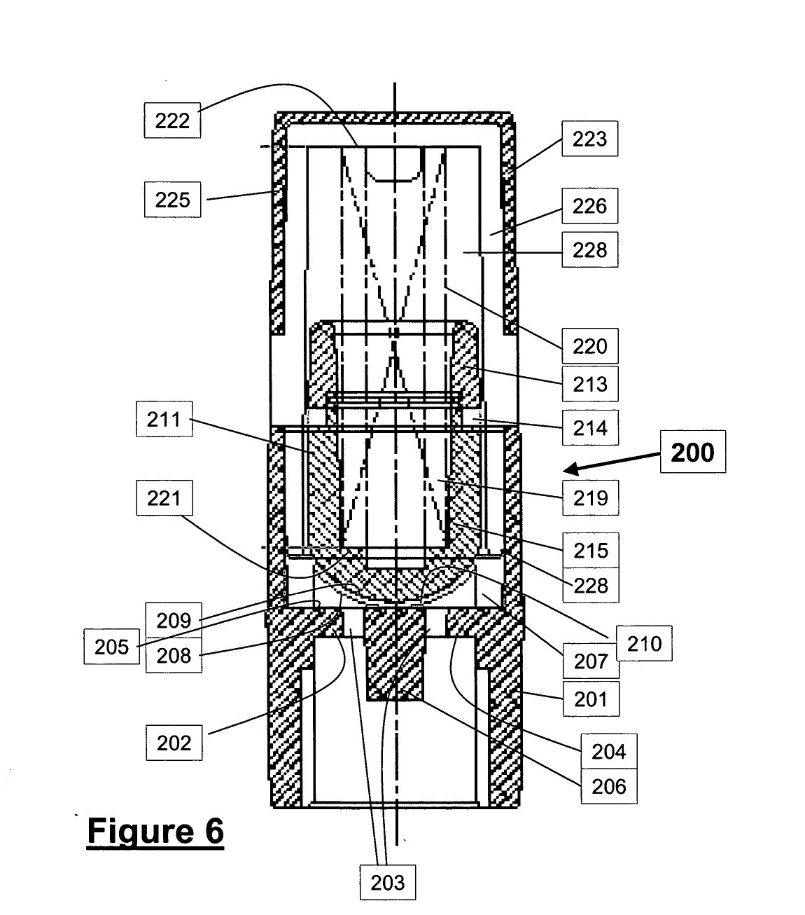

The diaphragm 207 may further include a concave (or “bowl-shaped”) portion 210 that allows the diaphragm 207 to deform when the air pressure differential on opposing sides 208, 209 thereof reaches a predetermined threshold level; deforming further as the air pressure differential increases, up to a maximum deformation (FIGS. 6-9). In preferred embodiments, the diaphragm 207 is concave with respect to the color indicator side 209 thereof, when the tire pressure being measured is insufficient or when the tire pressure monitoring apparatus 200 is not coupled to a tire (FIG. 6). Further, in preferred embodiments, at the maximum deformation, the concave portion 210 of the diaphragm 207 is inverted from its original position (i.e., the concave portion 210 being deformed into a convex orientation); although in alternate embodiments of the present invention, the diaphragm 207 may not deform to the point that it inverts into a convex orientation.

The material utilized to construct the diaphragm 207 may be selected to equate with differing threshold levels (i.e., to configure the tire pressure monitoring apparatus 200 for use with different types of tires, each having different air pressure characteristics and requirements). As such, the tire pressure monitoring apparatus 200 of the present invention may be configured for use with a range of tires, such as bicycle tires, automobile tires, truck tires and other types of tires that will be apparent to one of skill in the art. In particular embodiments, the tire pressure monitoring apparatus 200 of the present invention may be suitable for use in monitoring the tire pressure of high pressure tires.

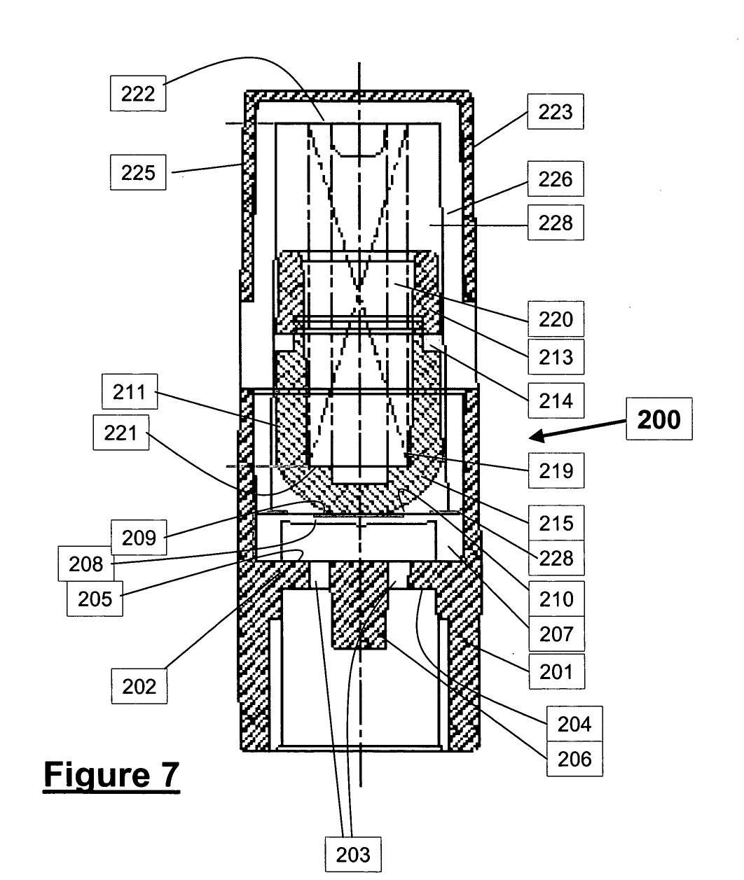

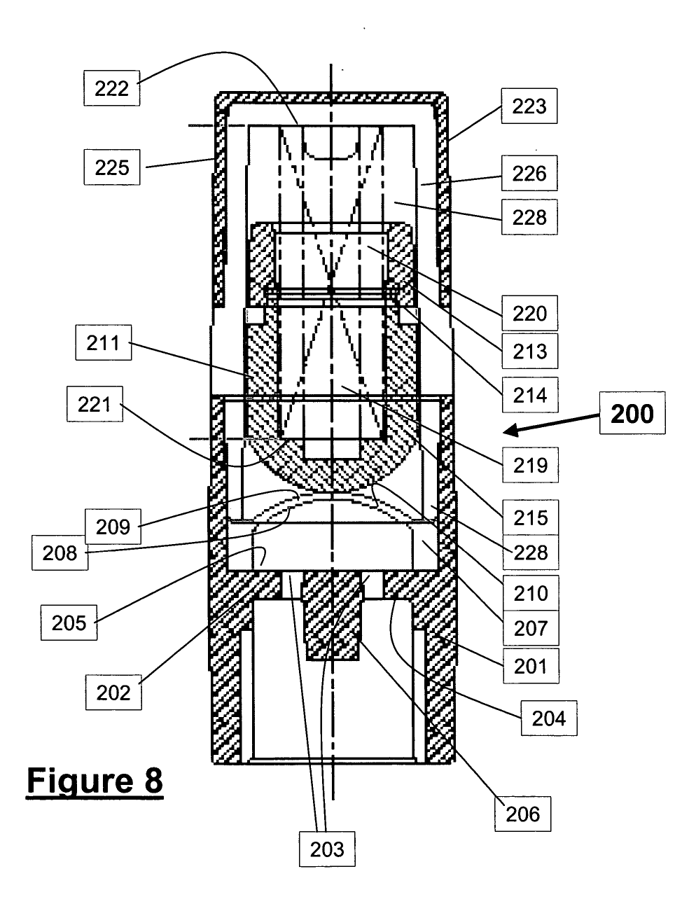

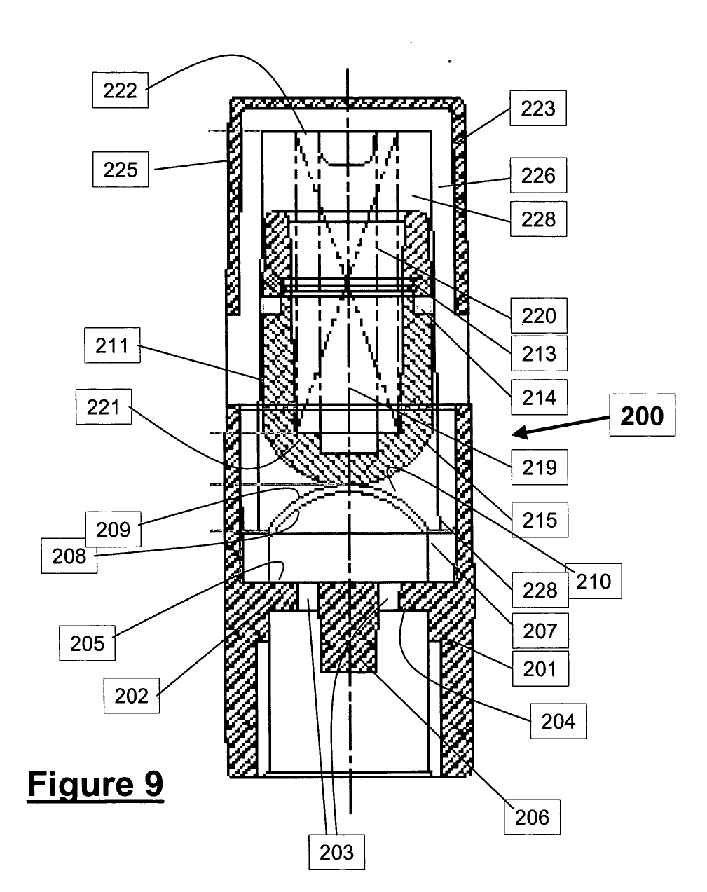

In those embodiments of the present invention wherein the housing 201 is substantially cylindrical, the diaphragm 207 may similarly be roughly cylindrical in shape, and the concave portion 210 disposed therein may be roughly circular. The concave portion 210 deforms upon application of an air pressure differential thereto, and is at or near a maximally deformed state when the tire pressure is at or near an optimum inflation level (FIG. 9); an intermediate deformation state when the tire pressure is within an acceptable range, although not optimum (i.e., tire pressure approximately 10% below optimum) (FIG. 8); another intermediate position when tire pressure is low (i.e., tire pressure approximately 20% below optimum) (FIG. 7); and a resting state when the tire pressure is insufficient (i.e., tire pressure greater than 20% below optimum) (FIG. 6).

The tire pressure monitoring apparatus 200 of the present invention may further include a color indicating piston 211 (FIG. 5). The colors that denote particular inflation levels of a tire may appear on different segments of the color indicating piston 211. In a preferred embodiment of the present invention, there are three such colors depicted on three segments of the color indicating piston 211: a first piston segment 215 (e.g., green), a second piston segment 213 (e.g., red) and a third piston segment 214 (e.g., yellow). The first piston segment 215 may indicate that the tire pressure is at least near optimum; the second piston segment 213 may indicate that the tire pressure is insufficient; and the third piston segment 214 may indicate that the tire pressure is within an acceptable range, although not near optimum. Therefore, the deformation state (i.e., including the resting state, when the second piston segment 213 is visible) of the diaphragm 207 may cause the corresponding piston segment to become visible through an observation window 227, described in greater detail below.

The color indicating piston 211 may further include an interior cavity 219, configured to receive the color indicating piston end 221 of a spring 220. The spring 220 may be included to provide mechanical resistance against the color indicating piston 211, such that the color indicating piston 211 remains mated to the diaphragm 207. In various embodiments of the present invention, the mechanical resistance provided by the spring 220 may aid in maintaining a proper mating between the color indicating piston 211 and the diaphragm 207, and may additionally aid in forcing the diaphragm 207 from a deformed state (FIGS. 7, 8 and 9) to a resting state (FIG. 6). However, in preferred embodiments of the present invention, the mechanical resistance provided by the spring 220 is only sufficient for maintaining a proper mating between the color indicating piston 211 and the diaphragm 207, and in such embodiments does not provide the requisite force to aid in transforming the diaphragm 207 back to a resting state.

As also depicted in FIG. 5, the tire pressure monitoring apparatus 200 may include a cover 223 that further includes an interior chamber 224 to operably receive a cover end 222 of the spring 220. The cover 223 may be geometrically configured to correspond to the shape of the housing 201 (i.e., it may be roughly cylindrical in shape in those embodiments wherein the housing 201 is roughly cylindrical in shape). In a preferred embodiment of the present invention, the cover 223 may also include both an opaque portion 225 and a transparent portion 226. The opaque portion 225 of the cover 223 may conceal at least a portion of the interior chamber 224. Furthermore, a segment of the transparent portion 226 is preferably left unobscured to provide an observation window 227 (FIGS. 6, 7, 8 and 9) through which one can view at least one color indicating the present inflation level of the tire to which the tire pressure monitoring device 200 is attached.

The cover 223 may further include a base 228 that contacts the diaphragm 207 when the cover 223 and housing 201 are assembled together. In this embodiment, depicted in FIG. 5, the cover 223 thereby aids in maintaining the pressure-fit between the diaphragm 207 and the housing 201, and secures the diaphragm 207 in place. This may aid in preventing the leakage of air from a tire through the tire pressure monitoring device 200, while also providing mechanical support for the diaphragm 207.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A tire pressure monitoring apparatus, comprising:
a housing;
a diaphragm configured within said housing to deform in response to an air pressure differential;
a cover coupled to said housing to retain said diaphragm within said housing, said cover further including a transparent window; and
a color indicating piston disposed within said housing between said diaphragm and said cover, said color indicating piston being visible through said transparent window and further including:
a first piston segment to indicate that a tire pressure is at least near optimum; and
a second piston segment to indicate that a tire pressure is insufficient,
wherein a deformation state of said diaphragm causes said first piston segment, said second piston segment, or a portion of each of two piston segments to become visible through said transparent window.

2. The tire pressure monitoring apparatus of claim 1, wherein said housing further includes a partition including at least one hole disposed therethrough.

3. The tire pressure monitoring apparatus of claim 2, wherein said partition includes a valve stem adapted to contact a central member of an air nozzle.

4. The tire pressure monitoring apparatus of claim 1, wherein said cover further includes an opaque portion.

5. The tire pressure monitoring apparatus of claim 1, wherein said color indicating piston includes a third piston segment to indicate that a tire pressure is within an acceptable range, although not near optimum, said third piston segment being disposed between said first piston segment and said second piston segment.

6. The tire pressure monitoring apparatus of claim 1, further including a spring to maintain contact between said color indicating piston and said cover, said spring being disposed between said color indicating piston and said cover.

7. The tire pressure monitoring apparatus of claim 1, further including an O-ring to provide a substantially airtight seal between said housing and an air nozzle to which said housing is adapted to couple.

8. The tire pressure monitoring apparatus of claim 1, wherein said diaphragm includes a center portion to deform in response to an air pressure differential.

9. The tire pressure monitoring apparatus of claim 8, wherein said center portion is concave with respect to said color indicating piston.

10. The tire pressure monitoring apparatus of claim 9, wherein said center portion inverts from a concave to a convex orientation when said tire pressure is at least near optimum.

11. A method for monitoring the air pressure of a tire, comprising:
observing a piston segment through a transparent window of an apparatus, comprising:
a housing;
a diaphragm configured within said housing to deform in response to an air pressure differential;
a cover coupled to said housing to retain said diaphragm within said housing, said cover further including a transparent window; and
a color indicating piston disposed within said housing between said diaphragm and said cover, said color indicating piston being visible through said transparent window and further including:
a first piston segment to indicate that a tire pressure is at least near optimum; and
a second piston segment to indicate that a tire pressure is insufficient,
wherein a deformation state of said diaphragm causes said first piston segment, said second piston segment, or a portion of each of two piston segments to become visible through said transparent window.

12. The method of claim 11, wherein said housing further includes a partition including at least one hole disposed therethrough.

13. The method of claim 12, wherein said partition includes a valve stem adapted to contact a central member of an air nozzle.

14. The method of claim 11, wherein said cover further includes an opaque portion.

15. The method of claim 11, wherein said color indicating piston includes a third piston segment to indicate that a tire pressure is within an acceptable range, although not near optimum, said third piston segment being disposed between aid first piston segment and said second piston segment.

16. The method of claim 11, wherein said apparatus further includes a spring to maintain contact between said color indicating piston and said cover, said spring being disposed between said color indicating piston and said cover.

17. The method of claim 11, wherein said apparatus further includes an O-ring to provide a substantially airtight seal between said housing and an air nozzle to which said housing is adapted to couple.

18. The method of claim 11, wherein said diaphragm includes a center portion to deform in response to an air pressure differential.

19. The method of claim 18, wherein said center portion is concave with respect to said color indicating piston.

20. The method of claim 19, wherein said center portion inverts from a concave to a convex orientation when said tire pressure is at least near optimum.

21. A method for monitoring the air pressure of a high pressure tire, comprising:
observing a piston segment through a transparent window of an apparatus, comprising:
a housing;
a diaphragm configured within said housing to deform in response to an air pressure differential;
a cover coupled to said housing to retain said diaphragm within said housing, said cover further including a transparent window; and
a color indicating piston disposed within said housing between said diaphragm and said cover, said color indicating piston being visible through said transparent window and further including:
a first piston segment to indicate that a tire pressure is at least near an optimum tire pressure; and
a second piston segment to indicate that a tire pressure is insufficient,
wherein a deformation state of said diaphragm causes said first piston segment, said second piston segment, or a portion of each of two piston segments to become visible through said transparent window, and
wherein said optimum tire pressure of said high pressure tire is at least about 60 psi.

22. The method of claim 21, wherein said housing further includes a partition including at least one hole disposed therethrough.

23. The method of claim 22, wherein said partition includes a valve stem adapted to contact a central member of an air nozzle.

24. The method of claim 21, wherein said cover further includes an opaque portion.

25. The method of claim 21, wherein said color indicating piston includes a third piston segment to indicate that a tire pressure is within an acceptable range, although not near optimum, said third piston segment being disposed between aid first piston segment and said second piston segment.

26. The method of claim 21, wherein said apparatus further includes a spring to maintain contact between said color indicating piston and said cover, said spring being disposed between said color indicating piston and said cover.

27. The method of claim 21, wherein said apparatus further includes an O-ring to provide a substantially airtight seal between said housing and an air nozzle to which said housing is adapted to couple.

28. The method of claim 21, wherein said diaphragm includes a center portion to deform in response to an air pressure differential.

29. The method of claim 28, wherein said center portion is concave with respect to said color indicating piston.

30. The method of claim 29, wherein said center portion inverts from a concave to a convex orientation when said tire pressure is at least near optimum.

31. A method for monitoring the air pressure of a high pressure tire, comprising:
observing a piston segment through a transparent window of a tire pressure monitoring apparatus,
wherein said high pressure tire has an optimum tire pressure of at least about 60 psi.
